(19) United States
(12) Patent Application Publication
(10) Pub. No.: US 2008/0215184 A1
(43) Pub. Date: Sep. 4, 2008

(54) Method for searching target object and following motion thereof through stereo vision processing and home intelligent service robot using the same

(75) Inventors: Seung Min Choi, Daejeon (KR); Ji Ho Chang, Yongin (KR); Jae Il Cho, Daejeon (KR); Dae Hwan Hwang, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 11/981,940

(22) Filed: Oct. 31, 2007

(30) Foreign Application Priority Data
Dec. 7, 2006 (KR) 10-2006-124036

(51) Int. Cl. G05B 19/02

(52) U.S. Cl. 700/259; 901/47

(57) ABSTRACT

A home intelligent service robot for recognizing a user and following the motion of a user and a method thereof are provided. The home intelligent service robot includes a driver, a vision processor, and a robot controller. The driver moves an intelligent service robot according to an input moving instruction. The vision processor captures images through at least two or more cameras in response to a capturing instruction for following a target object, minimizes the information amount of the captured image, and discriminates objects in the image into the target object and obstacles. The robot controller provides the capturing instruction for following the target object in a direction of collecting instruction information to the vision processor when the instruction information is collected from outside, and controls the intelligent service robot to follow and move the target object while avoiding obstacles based on the discriminating information from the vision processor.

### CLAIM OF PRIORITY

This application claims the benefit of Korean Patent Application No. 2006-124036 filed on Dec. 7, 2006 in the Korean Intellectual Property Office, the disclosure of which is incorporated herein by reference.

### BACKGROUND OF THE INVENTION

1. Field of the Invention

The present invention relates to a method for recognizing a user and following the motion of a user in a home intelligent service robot and, more particularly, to a technology for stably detecting a shape of a target object from obtained stereo vision image using the stereo matching result and the original image of the obtained stereo vision image and following the motion made by a corresponding target object.

This work was supported by the IT R&D program of MIC/IITA[2005-S-033-02, Embeded Component Technology and Standardization for URC]

2. Description of the Related Art

In order to process image data obtained from a robot for face detection or face recognition, the computation capability of the high performance processor is required. Conventionally, following two methods have been used for performing such a process requiring the computation capability of the high performance processor, such as the face detection process or the face recognition process.

As the first method, a robot processes image data using a high performance computer. As the second method, image data captured in a robot is transmitted to a network server, and the network server processes the image data transmitted from the robot.

In case of the first method, the size of the robot becomes enlarged, and the power consumption also increases. Therefore, it is difficult to apply the first method to a robot operated by battery power.

In case of the second method, the image processing load of a robot can be reduced because the second method is applied to a network based terminal robot in which a network server performs complicated computation. Since the network based terminal robot simply compresses image data and transmits the compressed image data to the server, excessive communication traffic may be generated due to the image data transmission (upload) between the terminal robot and the server. Also, such excessive communication traffic makes the speed of a robot to response collected image data slower.

Generally, conventional image compression algorithms such as MPEG, and H.264 have been used to compress image data to transmit the image data from a robot to a server in a network based intelligent service robot system. Since the conventional image compression algorithms compress unnecessary image regions such as background images included in image data as well as objects to be processed in a server, the compression efficiency thereof is degraded.

In a ubiquitous robot companion (URC) system, a server is connected to a plurality of intelligent robots through a network. In the URC system, it is required to reduce the load concentrated to the server by minimizing the quantity of image data transmitted to the server.

A conventional intelligent service robot generally uses image information collected from single camera, i.e., mono camera, for vision processing to recognize external environment and a user's face or height, or to follow the motions of a target object.

Furthermore, the conventional intelligent service robot dynamically uses sensing information obtained through ultra sonic wave or infrared rays to avoid obstacles while following the motions of the user. Due to such a way of driving the robot, the intelligent service robot needs excessive computation power and large amount of electric power. That is, it is not suitable to a robot that is driven by battery power.

In the case of a network based terminal robot in which complicated computation is performed at a server side, excessive traffic would be generated between a terminal robot and a server, and the response speed thereof is very slow.

Conventional stereo vision technologies that obtain image information through a pair of cameras mounted at the intelligent service robot are mostly related to stereo matching technology. The technology for recognizing a shape of a user and following the motion of the user through a pre-process and a post-process was disclosed through published or issued patents. The most of known related technologies and patents, however, fail to teach the detail thereof. Therefore, there is a demand for a technology for controlling an intelligent service robot stably following the motions of a target object while avoiding obstacles and providing small load to an internal processor.

Up to now, the home intelligent service robot uses a face recognition process, a face detection process, a pattern matching process, and color information to recognize a user. Such technologies degrades the performance of recognizing objects and following the motions thereof, requires a large memory and the mass amount of process computation, and is too sensitive to lighting when the intelligent service robot is moving.

### SUMMARY OF THE INVENTION

The present invention has been made to solve the foregoing problems of the prior art and therefore an aspect of the present invention is to provide a home intelligent service robot capable of detecting n target objects near thereto and providing an accurate shape of the target object through simple image processing using hardware and a method thereof.

Another aspect of the invention is to provide a home intelligent service robot capable of stably following the motions of a user while avoiding obstacles based on instruction information collected from peripheral environment, and a method thereof.

Still another aspect of the invention is to provide a home intelligent service robot capable of safely following the motions of a target object to a destination through collected stereo image information and original image while saving network resources for transmitting/receiving corresponding image data to/from a server, and a method thereof.

According to an aspect of the invention, the invention provides a home intelligent service robot includes a driver, a vision processor, and a robot controller. The driver moves an intelligent service robot according to an input moving instruction. The vision processor captures images through at least two or more cameras in response to a capturing instruction for following a target object, minimizes the information amount of the captured image, and discriminates objects in the image into the target object and obstacles. The robot controller provides the capturing instruction for following the target object in a direction of collecting instruction information to the vision processor when the instruction information is collected from outside, and controls the intelligent service robot to follow and move the target object while avoiding obstacles based on the discriminating information from the vision processor.

The vision processor may include: a stereo camera unit for collecting image information captured from the camera; an input image preprocessor for correcting the image information by performing an image preprocess on the collected image information from the stereo camera unit through a predetermined image processing scheme; a stereo matching unit for creating a disparity map by matching corresponding regions in the corrected images as one image; and an image postprocessor for discriminating different objects based on the disparity map after removing noise of the disparity map, extracting outlines of the discriminated objects using edge information of an original image, and identifying the target object and the obstacle based on the extracted outlines.

The image postprocessor may extract horizontal sizes and vertical sizes of the discriminated objects, and distances between the intelligent service robot to corresponding objects.

The intelligent service robot may further include an image output selector for selective outputting images outputted from the stereo camera unit, the input image preprocessor, the stereo matching unit, and the image postprocessor for transmitting the selected image to a robot server.

The stereo camera unit captures three-dimensional image using two cameras, a left camera and a right camera.

The input image postprocessor may use image process schemes such as calibration, scale down filtering, rectification, and brightness control for postprocessing. Also, the input image postprocessor may further use image processing schemes such as noise elimination, brightness level control, contrast control, histogram equalization, and edge detection on the images.

The instruction information may be information about motion made by the target object or sound localization.

According to another aspect of the invention, the invention provides a method of following a target object of an intelligent service robot. In the method, instruction information is collected from outside. The information amount of an captured image is minimized by capturing images through at least two or more cameras in a direction of collecting the collected instruction information, and objects in the image are discriminated into the target object and obstacles. Then, the robot moves to the target object while avoiding the obstacle based on the vision processing result.

In the step of minimizing the information and discriminating the objects, image information captured through the camera may be collected based on synchronization. Then, the image information may be corrected by performing an image preprocess on the collected image information through a predetermined image processing scheme, and a disparity map may be created by matching corresponding regions in the corrected image information as one image. Then, matching error of the disparity map and error generated from camera calibration may be minimized, and different objects may be discriminated after grouping the different objects according to brightness thereof base don the noise removed disparity map. Afterward, accurate outer shapes of objects may be extracted corresponding to location of objects discriminated and grouped according to the brightness in the disparity map by comparing and analyzing edge information of an original image. Then, the objects having the accurately discriminated outlines may be discriminated into the target object and the obstacle.

In the method, horizontal sizes and vertical seizes of the discriminated objects and distance information from a current location to corresponding objects may be calculated.

In the step of correcting, at least one of image process schemes such as calibration, scale down filtering, rectification, and brightness control may be performed for postprocessing. Also, in the step of correcting, at least one of image processing schemes such as noise elimination, brightness level control, contrast control, histogram equalization, and edge detection may be performed on the images.

According to the certain embodiment of the present invention, the robot terminal according can drive itself through small amount of computation using low cost stereo camera and internal hardware having a dedicated chip without using other sensors. That is, the amount of data to transmit the server can be reduced, thereby reducing the network traffic and the computation load of the server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a network based intelligent service robot system having a vision processing apparatus of a network based intelligent service robot according to an embodiment of the present invention;

FIG. 2 is a block diagram illustrating a vision processing apparatus of a network based home intelligent service robot according to an embodiment of the present invention;

FIG. 3 is a flowchart illustrating a method for following the motions of an target object in a home intelligent service robot according to an embodiment of the present invention; and

FIG. 4 is a flowchart illustrating a post-process step according to an embodiment of the present invention.

### DETAILED DESCRIPTION OF THE PREFERRED EMBODIMENT

Certain embodiments of the present invention will now be described in detail with reference to the accompanying drawings.

The present invention relates to a method for recognizing the motion of a target object through three-dimensional information created using stereo camera and stably following the target object by avoiding obstacles based on the recognizing result. The present invention also relates to a vision processing apparatus of an intelligent service robot, which detecting a target object and obstacles through image information by itself and following the target object based on the detecting result, thereby saving network resources to transmit and receives image data between a server and terminals, and a method thereof.

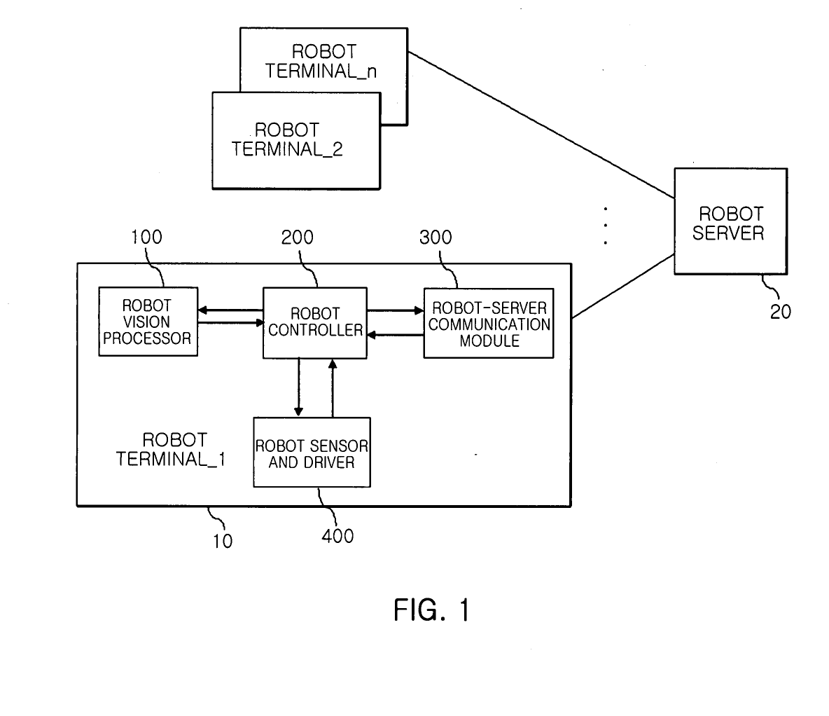

FIG. 1 is a block diagram illustrating a network based intelligent service robot system having a vision processing apparatus of a network based intelligent service robot according to an embodiment of the present invention.

As shown, the network based robot system includes one robot server 20 and a plurality of robot terminals 10 cooperating with the robot server 20.

In the network based robot system, the robot server 20 is connected to the robot terminals 10 and performs processes requiring a mass amount of computation and a high processing speed, which cannot be processed by robot terminals 10. Therefore, the robot terminals 10 can be embodied with low cost, and a user can be provided the high quality service with low cost.

The robot terminals 10 have the same structure in a view of major features. Each of the robot terminals 10 includes a robot vision processor 100, a robot sensor and driver 400, a robot server communication module 300, and a robot controller 200.

The robot vision processor 100 obtains and processes images. The robot sensor and driver 400 senses external environment and drives the robot terminals 10. The robot-server communication module 300 provides a communication function for communicating the robot server 20 with the robot terminals 10. The robot controller 200 generally controls overall operations of the robot terminals 10.

As described above, the network based robot system configured of single robot server 20 and the plurality of robot terminals 10 concentrates the load requiring a mass amount of complicated application or a high speed computation, which cannot be processed in the robot terminals 10, to the robot server 20 connected to the robot terminals 10 through a network. Therefore, the robot terminals 10 can be embodied with low cost, and a user can be provided the high quality service with low cost.

In order to use a network based intelligent service to provide various service with low cost, it must consider reduction of a cost, power consumption, and a weight of a robot terminal. Therefore, the robot controller 200 of the robot terminal 10 according to the present embodiment is embodied using low power consumption embedded processor which has advantages in views of price, power consumption, and weight without using a typical personal computer.

In order to reduce the cost thereof, the communication cost of using a network must be reduced. In the case of an Internet usage based charge system, it is better to avoid excessive communication between a robot terminal 10 and a robot server 20 in network based intelligent robot application.

If the robot controller 200 of the robot terminal 10 is embodied with comparatively low computing power and the robot server 20 is designed to process complicated applications, the robot terminal 10 can be realize with comparative low cost. On the contrary, the communication traffic to the robot server 20 increases because the robot server 20 processes many application s to provide a predetermined service. Therefore, the communication cost increases.

If a robot terminal 10 is designed to process more functions in order to reduce the cost of communicating to the robot server 20, the communication cost can be reduced but the processing load of the robot terminal 10 becomes increased. Comparatively, the robot controller 200 must be embodied with high cost to have a high computing power.

Therefore, it is better to balance the two considerations for reducing the overall cost due to the cost characteristics of the network based intelligent service robot system. Especially, the communication traffic between the robot server 20 and the robot terminal 10 is an important factor that influences not only the communication cost but also the system stability because one robot server 20 cooperates with a plurality of robot terminals 10 as shown in FIG. 1.

In the network based intelligent service robot system according to the present embodiment, a network based intelligent service robot 10 for processing image data that occupies the most of communication traffic to the robot server 20 without requiring the high cost of a high power processor, and a control method thereof are proposed.

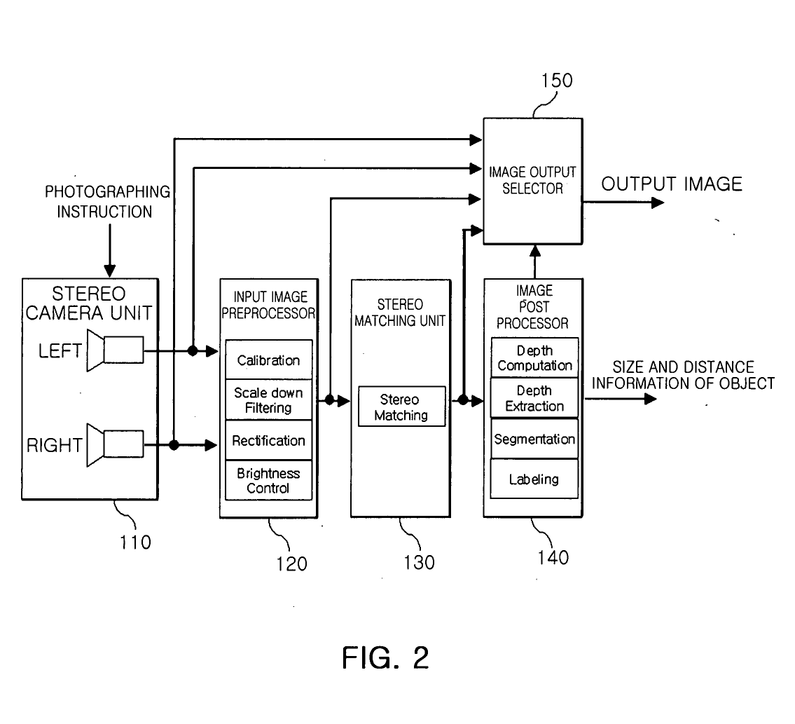

In order to drive a robot terminal 10 in the conventional network based intelligent service robot system, the robot terminal 10 transmits obtained image data to the robot server 20, and the robot server 20 performs related processes for recognizing obstacles to drive the robot terminal 10, and controls the robot terminal 10 based on the processing result. In order to overcome the problem of the excessive processing load of the robot server 20 and the excessive traffic load of the network, a robot terminal according to an embodiment of the present invention includes a vision processing apparatus as shown in FIG. 2. That is, the robot terminal according to the present embodiment can process information to move or drive through a vision processing apparatus embodied with a low cost dedicated chip or a low cost embedded processor without transmitting information to the robot server 20.

FIG. 2 is block diagram illustrating a vision processor 100 of a network based intelligent service robot shown in FIG. 1 according to an embodiment of the present invention.

As shown, the robot vision processor 100 of the network based intelligent service robot includes a stereo camera unit 100, an input image pre-processor 120, a stereo matching unit 130, an image post-processor 140, and an image output selector 150.

The stereo camera unit 110 obtains images from a left camera and a right camera. When instruction information is collected from the periphery of the robot terminal, the robot controller 200 inputs a photographing instruction to the stereo camera unit 200 to collect image information in a direction of collecting the instruction information. The instruction information may be motion information generated from a target object, for example a hand signal, or sound localization information.

The input image preprocessor 120 processes the images inputted from the cameras of the stereo camera unit 110 through various image processing scheme in order to enable the stereo matching unit 130 to easily perform the stereo matching, thereby improving overall performance. The image processing schemes of the input image preprocessor 120 includes calibration, scale down filtering, rectification, and brightness control.

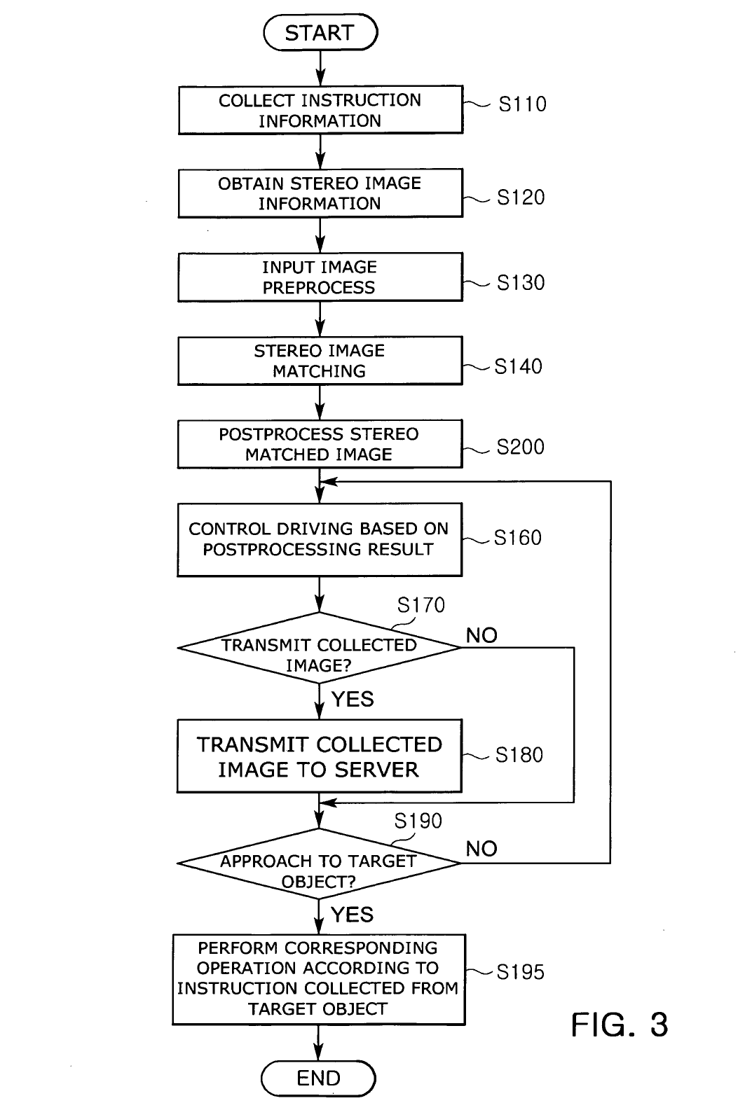

Also, the input image preprocessor 120 removes noise from image information captured from the left and right cameras. If the images inputted from two cameras are different in the brightness level or contrast, the input image preprocessor 120 processes the image information to have the same environment. The input image preprocessor 120 performs histogram equalization and edge detection according to needs, thereby improving overall quality. As a result, the input image preprocessor 120 outputs images like pictures (b) of FIG. 3.

The stereo matching unit 130 performs the stereo matching by finding corresponding areas from left and right images calibrated from the input image preprocessor 120 and calculates a disparity map based on the result of the stereo matching. Then, the stereo matching unit 130 synchronizes the left and right images into one image based on the result of stereo matching.

The image postprocessor 140 creates a depth map through depth computation and depth extraction based on the disparity map from the stereo matching unit 130. Herein, the image post processor 140 performs segmentation and labeling for discriminating different objects from the extracted depth map.

The image postprocessor 140 according to the present embodiment measures horizontal and vertical sizes of objects included and discriminated in the created depth map, and distances from the robot terminal 10 to corresponding objects, and outputs the measured horizontal and vertical sizes and the distances. Therefore, the image postprocessor 140 determines whether corresponding objects are a target object to move or obstacles based on the measured information of each object.

The robot controller 200 controls the robot sensor and driver 400 to drive the robot terminal 10 to follow or to move to the target object based on the processing result from the image postprocessor 140 without communicating with the robot server 200.

The image output selector 150 selects one of images outputted from the stereo camera unit 100, the input image preprocessor 120, the stereo matching unit 130, and the image postprocessor 140 according to input instruction, and outputs the selected image. Therefore, the robot controller 200 can selectively output the image from the image output selector 150 to internal elements or to the robot server 20.

As described above, the vision processing apparatus 100 according to the present embodiment enables the intelligent service robot 10 to drive or to move to a target object without requiring other sensors by extracting three dimensional distance information of external objects from images captured from the stereo camera unit 110 and processing the stereo camera images.

Since it is not required to transmit the image data occupying the most of traffic to the robot server 20, the network traffic between the robot terminal 10 and the robot server 20 can be significantly reduced, thereby reducing the cost for network connection and securing the stability of the network based intelligent service robot system in which single robot server 20 cooperates with a plurality of robot terminals 10.

FIG. 3 is a flowchart illustrating a method of following a target object of an intelligent service robot according to an embodiment of the present invention.

Referring to FIG. 3, when the robot controller 200 collects calling-up instruction information through provided sensors at step S110, the robot controller 200 controls the stereo camera unit 110 to capture stereo image information through the stereo camera. When the stereo camera unit 110 receives the photograph instruction from the robot controller 200, the stereo camera unit 110 operates Pan/Tilt of cameras, turns a photographing direction to a direction of collecting instruction information, and captures the image information therefrom at step S120. In the present embodiment, the stereo camera unit 110 captures three-dimensional image information through stereo camera in one frame at a time.

After obtaining the captured image information from the stereo camera unit 110, the robot controller 200 controls the input image preprocessor 120 to perform image preprocesses on the obtained image information at step S130. In the present embodiment, the input image preprocessor 120 applies images created by crossing left and right original images one pixel by one pixel, performs image processing schemes such as brightness level control, contrast control, histogram equalization, and edge detection on the created images for preprocessing the input image. The input image preprocessor 120 also encodes the images created by crossing left and right original images one pixel by one pixel and transmits the encoded images to the robot server 20. The robot server 20 receives the encoded image by decoding stream using a corresponding image processing scheme.

When the input image preprocessor 120 performs the preprocess on the images captured from each camera, the robot controller 20 controls the stereo matching unit 130 to perform stereo image matching on the preprocessed images at step S140.

After the stereo matching unit 130 performs the stereo matching on the stereo image, the robot control 200 controls the image postprocessor to perform the postprocess on the matched image at step S200. Accordingly, it obtains information about the sizes of objects included in the image, distances from the robot terminal 10 to the corresponding objects, target objects and obstacles.

The robot controller 200 controls the robot terminal 10 to avoid obstacles and to move to the target object based on the postprocess result at step S160. Herein, the robot controller 200 determines whether or not an instruction for transmitting image information collected from the stereo camera unit 110 or processed at each image processors 120, 130, and 140 is received or not at step S170.

If the transmission instruction is received, the robot controller 200 transmits image information, which is created by performing a corresponding image process on image captured from the stereo camera unit 110, to the robot server 20 through the robot server communication module 300 at step S180.

The robot controller 200 determines whether the robot terminal 10 approaches to a target object within a predetermined distance range or not at step S190 while moving to the target object based on the postprocess result. If the robot controller 200 determines that the robot terminal 10 reaches to the target object with the predetermined distance range, the robot controller 200 performs a corresponding operation in response an instruction collected from the target object at step 195.

In the case of collecting a user's calling-up instruction, it assumes that human is only moving object when the robot terminal 10 turns to and looks at the direction of collecting the calling-up instruction information in the present embodiment in the present invention. Such an assumption can be applied to a home service robot because moving objects in home are generally human, pets, and robots. Especially, since the home service robot looks at objects at a predetermined height, it is possible to design the home service robot to sense motions made by human, not by pets.

Meanwhile, in a case that the robot terminal 10 follows human, if the robot controller 200 determines that the second object is human, the robot terminal 10 moves toward the second object. When the robot terminal 10 avoids and passes by the second object, the robot terminal 10 recognizes the first object as human.

As another example, the robot controller 200 determines that the first object is human and moves to the first object. While moving to the first object, if any object or human appears between the robot terminal 10 and the first object, the robot terminal 10 recognizes the newly appeared object as obstacle.

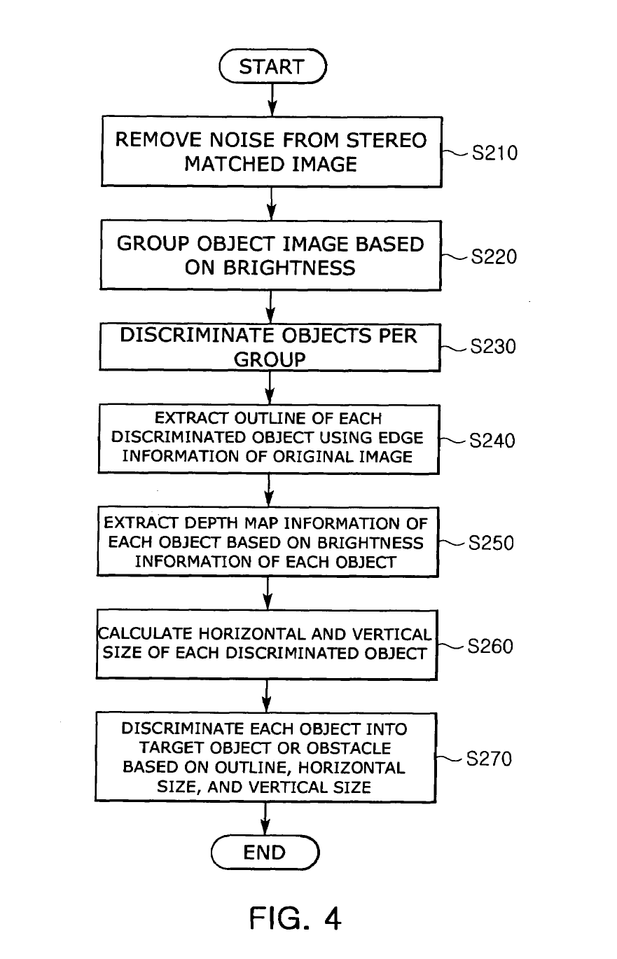

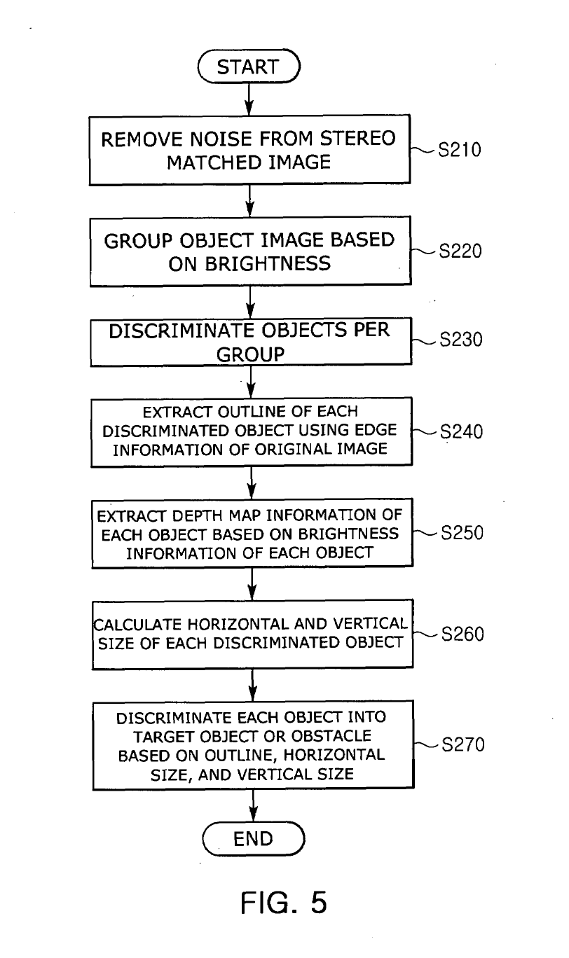

FIG. 4 is a flowchart illustrating the image post-processing step S200 according to an embodiment of the present invention.

As shown, the image postprocessor 140 removes the error of stereo matching from the matched image from the stereo matching unit 130 or removes the noise from the stereo camera unit 110 using a low pass filter (LPF) at step S210. Herein, a mode filter or a median filter can be used as the low pass filter. The image postprocessor 140 can reset the size of rectangular noise, and dynamically remove the noise of matching error according to the variation of background environment.

After removing noises, the image postprocessor 140 groups object images based on brightness of result images at step S220. After grouping the object images according to the brightness, the image postprocessor 140 segments each object per group at step S230.

Afterward, the image postprocessor 140 extracts an outline (external shape) of each discriminated object using edge information of original/image at step S240. Since the discriminated objects have brightness information, the image postprocessor 140 extracts depth mage information of each object based on the brightness information of each object at step S250.

Then, the image postprocessor 140 calculates a horizontal size and a vertical size of the discriminated object at step S260. Finally, the image postprocessor 140 determines whether each object is a target object or an obstacle based on the outline, the horizontal size, and the vertical size of the discriminated object at step S270.

As described above, the robot terminal according to the certain embodiment of the present invention can drive itself through small amount of computation using low cost stereo camera and internal hardware having a dedicated chip without using other sensors. That is, the amount of data to transmit the server can be reduced, thereby reducing the network traffic and the computation load of the server.

Furthermore, the vision processing apparatus of the network based intelligent service robot according to the present embodiment enables the intelligent service robot 10 to drive or to move to a target object without requiring other sensors by extracting three dimensional distance information of external objects from images captured from the stereo camera unit 110 and processing the stereo camera images.

Moreover, since it is not required to transmit the image data occupying the most of traffic to the robot server, the network traffic between the robot terminal and the robot server can be significantly reduced, thereby reducing the cost for network connection and securing the stability of the network based intelligent service robot system in which single robot server cooperates with a plurality of robot terminals.

While the present invention has been shown and described in connection with the preferred embodiments, it will be apparent to those skilled in the art that modifications and variations can be made without departing from the spirit and scope of the invention as defined by the appended claims.

What is claimed is:

1. An intelligent service robot comprising:
a driver for moving an intelligent service robot according to an input moving instruction;
a vision processor for capturing images through at least two or more cameras in response to a capturing instruction for following a target object, minimizing the information amount of the captured image, and discriminating objects in the image into the target object and obstacles; and
a robot controller for providing the capturing instruction for following the target object in a direction of collecting instruction information to the vision processor when the instruction information is collected from outside, and controlling the intelligent service robot to follow and move the target object while avoiding obstacles based on the discriminating information from the vision processor.

2. The intelligent service robot according to claim 1, wherein the vision processor includes:
a stereo camera unit for collecting image information captured from the camera;
an input image preprocessor for correcting the image information by performing an image preprocess on the collected image information from the stereo camera unit through a predetermined image processing scheme;
a stereo matching unit for creating a disparity map by matching corresponding regions in the corrected images as one image; and
an image postprocessor for discriminating different objects based on the disparity map after removing noise of the disparity map, extracting outlines of the discriminated objects using edge information of an original image, and identifying the target object and the obstacle based on the extracted outlines.

3. The intelligent service robot according to claim 2, wherein the image postprocessor extracts horizontal sizes and vertical sizes of the discriminated objects, and distances between the intelligent service robot to corresponding objects.

4. The intelligent service robot according to claim 2, further comprising an image output selector for selectively outputting images outputted from the stereo camera unit, the input image preprocessor, the stereo matching unit, and the image postprocessor for transmitting the selected image to a robot server.

5. The intelligent service robot according to claim 2, wherein the image postprocessor removes matching error of the disparity map or noise generated by mismatch of camera calibration through a low pass filter.

6. The intelligent service robot according to claim 5, wherein the low pass filter is a mode filter or a median filter.

7. The intelligent service robot according to claim 2, wherein the input image preprocessor uses image processing schemes by at least one of brightness level control, contrast control, histogram equalization, and edge detection based on left and right original images and images created by crossing left and right original image one pixel by one pixel.

8. The intelligent service robot according to claim 7, wherein the input image preprocessor encodes an image created by crossing left and right original images one pixel by one pixel and transmits the encoded images to the robot server, and the robot server receives images by decoding stream using a corresponding image processing scheme.

9. The intelligent service robot according to claim 1, wherein the instruction information is information about motion made by the target object or sound localization.

10. A method of following a target object of an intelligent service robot comprising:
collecting instruction information from outside;
minimizing information amount of an captured image by capturing images through at least two or more cameras in a direction of collecting the collected instruction information, and discriminating objects in the image into the target object and obstacles; and
moving to the target object while avoiding the obstacle based on the vision processing result.

11. The method according to claim 10, wherein the step of minimizing the information and discriminating the objects includes:
collecting image information captured through the camera based on synchronization;
correcting the image information by performing an image preprocess on the collected image information through a predetermined image processing scheme;
creating a disparity map by matching corresponding regions in the corrected image information as one image;
minimizing matching error of the disparity map and error generated from camera calibration;
discriminating different objects after grouping the different objects according to brightness thereof based on the noise removed disparity map;
creating accurate outer shapes of objects corresponding to location of objects discriminated and grouped according to the brightness in the disparity map by comparing and analyzing edge information of an original image; and
discriminating the objects having the accurately discriminated outlines into the target object and the obstacle.

12. The method according to claim 11, further comprising extracting horizontal sizes and vertical seizes of the discriminated objects and distance information from a current location to corresponding objects.
